(19) United States
(12) Patent Application Publication
(10) Pub. No.: US 2024/0092565 A1
(43) Pub. Date: Mar. 21, 2024

(54) Container Lids

(71) Applicant: Environmental Metal Works Ltd., Two Hills (CA)

(72) Inventors: Lindsay Mark Haag, Two Hills (CA); Cornelio Neufeld, Hairy Hill (CA); Juan Fehr, Two Hills (CA); Johan Guenther, Two Hills (CA)

(73) Assignee: Environmental Metal Works Ltd., Two Hills, AB (CA)

(21) Appl. No.: 18/254,072

(22) PCT Filed: Nov. 27, 2020
(86) PCT No.: PCT/IB2020/061242

§ 371 Date: May 23, 2023

(51) Int. Cl. B65D 90/64; B65D 88/12; B65D 90/62

(52) U.S. Cl. CPC B65D 90/64; B65D 88/126; B65D 90/623; B65D 2590/547

(57) ABSTRACT

An example of an apparatus is provided. The apparatus includes a first track to mount on a container along a first side of the container opening. The apparatus further includes a second track to mount on the container along a second side of the container opening. The first side is opposite the second side. In addition, the apparatus includes a frame engaged with the first track and the second track. The frame is to move along the first track and the second track between an open position and a closed position. The apparatus also includes a first panel to mounted on the frame to cover a first portion of the container opening. The apparatus further includes a second panel to mounted on the frame to cover a second portion of the container opening. The first panel is to overlap the second panel by a distance.

### BACKGROUND

Containers are used to collect and contain various content which may include garbage, debris, liquids and other types of content. The containers may be part of a vehicle, such as a truck, or may be standalone containers that may be dropped off at a site and picked up at a later time after loading or unloading. For example, a container may be configured to be delivered and removed via specialized trucks which allow the container to roll on and off the truck. Such trucks may include a tilting bed, a winch system, and/or hooks in order to facilitate loading and unloading the container from the truck. Alternately, some containers may be delivered and removed with a crane that may be included on a specialized truck or a separate crane located at loading and unloading sites.

Containers may also include lids to keep the contents from falling out, such as during transport, or to restrict access when valuable contents such as copper or other metals are stored therein. The container lid may also be installed to comply with environmental regulations in some areas where storm water exposure is a concern, to secure the contents from theft, to reduce unauthorized dumping into the container, and to otherwise protect against unwanted or unauthorized access to the container or its contents. The lids placed on containers include a wide variety of lids where some types may be particularly advantageous for a specific application. One such type of cover may be a tarpaulin. Another type of cover may be constructed of heavy duty steel panels secured to the container during assembly.

### BRIEF DESCRIPTION OF THE DRAWINGS

Reference will now be made, by way of example only, to the accompanying drawings in which:

FIG. 1A is a perspective view of an example of an apparatus to cover an opening of a container;

FIG. 1B is a side view of the example shown in FIG. 1A of an apparatus to cover an opening of a container;

FIG. 2A is a perspective view of the example shown in FIG. 1A of an apparatus to cover an opening of a container installed on the container in the closed position;

FIG. 2B is a perspective view of the example shown in FIG. 1A of an apparatus to cover an opening of a container installed on the container in the open position;

FIG. 3 is a perspective view of the frame of the apparatus shown in figure illustrated in greater detail;

FIG. 4A is a perspective view of another example of a frame to be used in an apparatus to cover an opening of a container;

FIG. 4B is a perspective view of another example of a frame to be used in an apparatus to cover an opening of a container;

FIG. 4C is a perspective view of another example of a frame to be used in an apparatus to cover an opening of a container;

FIG. 5A is a perspective view of another example of an apparatus to cover an opening of a container;

FIG. 5B is a side view of the example shown in FIG. 5A of an apparatus to cover an opening of a container;

FIG. 5C is a side view of the example shown in FIG. 5A from the opposite side of FIG. 5B of an apparatus to cover an opening of a container;

FIG. 6A is a perspective view of the example shown in FIG. 5A of an apparatus to cover an opening of a container installed on the container in the closed position;

FIG. 6B is a perspective view of the example shown in FIG. 5A of an apparatus to cover an opening of a container installed on the container in the open position;

FIG. 6C is a close-up view of the example mechanism shown in FIG. 6B;

FIG. 7 is a cross section view of the example of an apparatus shown in FIG. 6A to cover an opening of a container about the line 7-7; and

FIG. 8 is a flowchart of an example of a method of installing an apparatus on a container to cover an opening.

### DETAILED DESCRIPTION

As used herein, any usage of terms that suggest an absolute orientation (e.g. “top”, “bottom”, “up”, “down”, “left”, “right”, “low”, “high”, etc.) may be for illustrative convenience and refer to the orientation shown in a particular figure. However, such terms are not to be construed in a limiting sense as it is contemplated that various components will, in practice, be utilized in orientations that are the same as, or different than those described or shown.

Containers are used to collect and contain various content which may include garbage, debris, liquids, and other types of content. Containers may have an opening on the top to receive and remove the content. These openings may have lids to also include lids to keep the contents from falling out, such as during transport, or to restrict access when valuable contents such as copper or other metals are stored therein. Container lids may also be installed to comply with environmental regulations in some areas where storm water exposure is a concern, to secure the contents from theft, to reduce unauthorized dumping into the container, and to otherwise protect against unwanted or unauthorized access to the container or its contents.

Although there are some standard sizes of containers, the containers come in various sizes with openings that may also vary in size to accommodate different applications. For example, smaller containers may be used in confined locations for maneuverability and larger containers may be used in spaces to allow for larger loads. Accordingly, lids for the containers are typically manufactured with the containers that are to be sold with lids. In some situations, an aftermarket lid may be installed by a user after delivery of the container. Alternatively, a lid may be manufactured by a separate party from the container manufacturer to be assembled at a later step.

An apparatus is provided to cover an opening of a container. The apparatus may be configured to be delivered as a kit for on-site assembly or to container manufactures to be assembled as an optional finishing step to a container. The apparatus provides a rolling lid that may be opened to the side of the container. The rolling lid in the present examples is to be assembled with multiple panels that may overlap to cover openings of various sizes. Accordingly, the panels of the apparatus may be used for containers across a continuum of dimension by adding a sufficient number of panels to cover the opening and to overlap the panels by a varying amount to achieve a target fit.

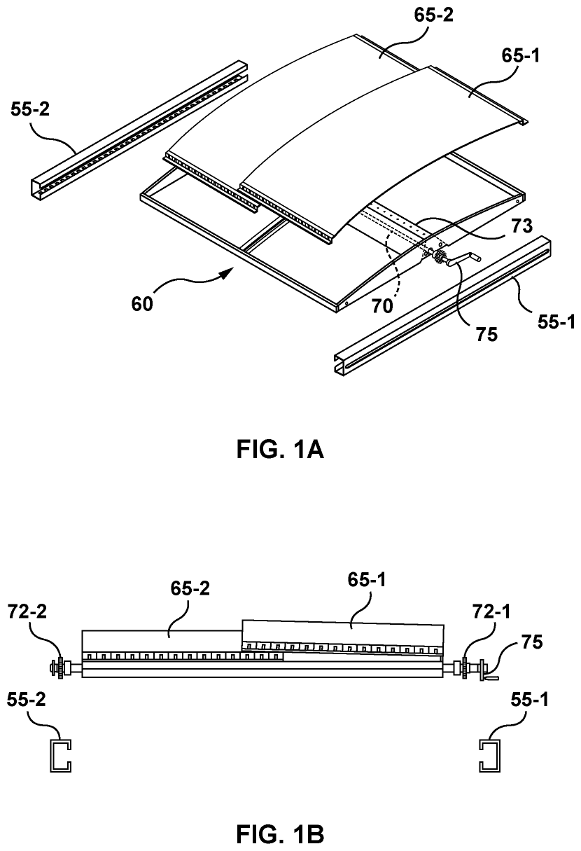

Referring to FIGS. 1A and 1B, an apparatus 50 to form a lid to cover a container opening is generally shown. It is to be appreciated by a person of skill with the benefit of this description that the apparatus 50 may include variants with additional features and take different forms. For example, the size of the apparatus 50 is not particularly limited and may be varied depending on the size and type of container onto which the apparatus is mounted. Furthermore, the shape of the apparatus 50 may also be modified where the shape of the container opening or the container itself is not rectangular. In the present example, the apparatus 50 includes tracks 55-1, 55-2 (generically, these tracks are referred to herein as “track 55” and collectively they are referred to as “tracks 55”, this nomenclature is used elsewhere in this description), a frame 60, and panels 65-1, 65-2 (generically, these panels are referred to herein as “panel 65” and collectively they are referred to as “panels 65”, this nomenclature is used elsewhere in this description).

The tracks 55 are generally to be mounted to a container along opposite sides of an opening on the container. The tracks 55 are not particularly limited and may be any type of track that allows for the frame 60 to move between an open position to expose the opening of a container and a closed position to cover the opening of the container. In the present example, the tracks 55 may engage opposite ends on an axle 70 of the frame 60 to allow each end of the axle 70 to move along the track.

The manner by which the axle 70 moves along the tracks 55 is not particularly limited and that various mechanisms are contemplated. For example, the axle 70 may engage a track 55 with a rack-and-pinion mechanism. In this example, each of the tracks 55 include a plurality of openings to form a rack. In other examples, each of the tracks 55 may include valleys or a plurality of detents to form the rack of the rack-and-pinion mechanism. The axle 70 may include a pinion 72-1, 72-2 at each end where the pinion is to roll along a respective track 55. It is to be appreciated by a person of skill with the benefit of this description that a rack-and-pinion mechanism may securely engage the axle 70 to the tracks 55 such that the axle 70 will not slip relative to the tracks 55. In particular, the lid may then be locked in a position, such as an open position or a closed position by securing the pinion 72-1, 72-2 from rotating. Accordingly, for examples where the pinion 72-1, 72-2 is locked to the axle 70 and controlled by a handle 75, the lid may be locked in position by locking the handle 75.

In another example, the axle 70 may engage a track 55 with a roller configured to roll along the track 55. In this example, the axle 70 may include a roller at each end where each roller is to roll along a respective track 55. In the present example, the roller may frictionally engage with a track 55. The contact surfaces of the roller and the track 55 may include various nonslip materials or coatings to reduce slippage. Similar to the rack-and-pinions system, it is to be appreciated by a person of skill with the benefit of this description that the lid may then be locked in a position, such as an open position or a closed position by securing a roller from rotating. For examples where the roller is locked to the axle 70 and controlled by the handle 75, the lid may be locked in position by locking the handle 75.

In a further example, the axle 70 may engage the track 55 with a sliding mechanism. For example, the axle 70 may include a guide at each end where each guide is to engage the track 55 in a slidable manner. The contact surfaces of the connector and the track 55 may be smooth to allow for sliding. In some examples, the connector may also be lubricated to facilitate sliding along the track 55. It is to be appreciated by a person of skill with the benefit of this description that the connector may be locked along the track 55, such as an open position or a closed position, with a locking mechanism, such as a clamp or pin. For example, the track 55 may include a plurality of openings to insert a pin to effectively block the connector from sliding past. Alternatively, a clamp may be placed on the track 55 to block the connector from sliding freely along the track 55.

The material from which each of the tracks 55 are constructed is not particularly limited. In the present example, the tracks 55 are made from galvanized steel. In other examples, the tracks 55 are made from other suitable materials with the mechanical properties sufficient to support the forces associated with the movement and weight of the frame 60 and the panels 65. For example, the tracks 55 may be made from stainless steel, aluminum, other metals, plastics, or other composite materials. The manner by which the track 55 is mounted onto the container is not particularly limited. For example, the track 55 may be mounted using a fastener, such as a rivet, bolt, or clips. In other examples, the track 55 may be welded or soldered onto the container. In further examples, the tracks 55 may also be mounted using magnetic coupling or other removable securing mechanisms.

It is to be appreciated by a person of skill with the benefit of this description that the size of the tracks 55 are not particularly limited and is generally dependent on the size of the opening on the container to which the tracks 55 are to be mounted. In the present example, each track 55 is to extend substantially along the entire length of a side of a rectangular opening of the container. In other examples where the opening is not rectangular, the tracks 55 may extend along near the opening for a predetermined length, such as the greatest width of the opening. The tracks 55 allow the frame 60 and panels 65 to be translated between an open position and a closed position. Furthermore, it is to be appreciated that in some examples, the tracks 55 may not be straight such that the frame 60 and panels 65 do not move in a straight line between the open position and the closed position. The tracks 55 may be machined, stamped, cut, or molded into the predetermined length to accommodate a target opening size. In some examples, the tracks 55 be adjustable such that it may be adjusted to an appropriate length prior to mounting beside the opening of the container.

The frame 60 is to engage with the tracks 55 to move between a closed position and an open position. The manner by which the frame 60 engages with the tracks 55 is not particularly limited. In the present example, the frame 60 may include an axle 70 configured to engage the tracks 55 at each end as described above. Although the ends of the axle 70 may provide a primary point of contact between the frame and the tracks, it is to be appreciated that other points of frame 60, such as the corners, may also contact the tracks 55. For example, rollers may be placed at the corners of the frame to facilitate movement and distribute weight along the tracks 55.

Furthermore, the frame 60 is to generally support a plurality of panels 65 above the opening of the container. For example, the panels 65 may be secured to receiving points on the frame 60 to received complementary features on the panels 65. Accordingly, the panels 65 are to cover the entire opening of the frame 60 to form a lid over the opening of the container. The manner by which the panels 65 are secured to the frame 60 is not particularly limited and dependent on the materials of the frame 60 and the panels 65. For example, the panels 65 may be mounted using a friction fit or adhesives. In other examples, the panels 65 may be secured using a fastener, such as a rivet, bolt, or clips.

The material from which each of the frame 60 is constructed is not particularly limited. In the present example, the frame 60 is made from galvanized steel. In other examples, the frame 60 is made from other suitable materials with the mechanical properties sufficient to support the panels 65. For example, the frame 60 may be made from stainless steel, aluminum, other metals, plastics, or other composite materials.

It is to be appreciated by a person of skill with the benefit of this description that the size of the frame 60 is not particularly limited and is generally dependent on the size of the opening on the container to which the frame 60 is to support panels 65 to cover. In the present example, the frame 60 is form a shape that compliments the opening of the container such that it may be fully covered. In some examples, the frame 60 may extend beyond the edges of the opening of the container, especially in examples where the opening has an irregular shape. The frame 60 may be machined, stamped, cut, or molded into the predetermined dimension to accommodate a target opening size. Accordingly, the frame 60 may be available in multiple sizes to fit various types of containers. In some examples, the frame 60 be adjustable such that it may be adjusted to an appropriate length prior to installation on a container.

In the present example, the panels 65 are to be mounted on the frame 60. It is to be appreciated by a person of skill that each of the panels 65 are generally smaller than the opening of the frame 60 such that each panel 65 is to cover only a portion of the opening defined by the frame 60. In general, the panels 65 are prefabricated to be substantially identical in size. Accordingly, the panels 65 may overlap in order to fit within the frame 60. Since the frame 60 is generally rectangular, the panels 65 may have a dimension equal to width of the frame and another dimension to be a portion of the length. A plurality of overlapping panels 65 may overlap by a target distance that may vary depending on the size of the opening of the container. Therefore, the use of multiple panels 65 manufactured on the same manufacturing line may accommodate a variety of container sizes by simply adding sufficient number of panels 65. In the present example, the panels 65 may simply overlap such that the rigidity of the panels 65 hold the shape. In other examples, the panels 65 may be connected with fasteners, adhesives, or connector elements.

The material from which each of each panel 65 is constructed is not particularly limited. In the present example, each panel 65 may be made from a plastic material, fiberglass, or other composite material for their lightweight and durable properties. In other examples, the panels 65 may be made from galvanized steel or other metals.

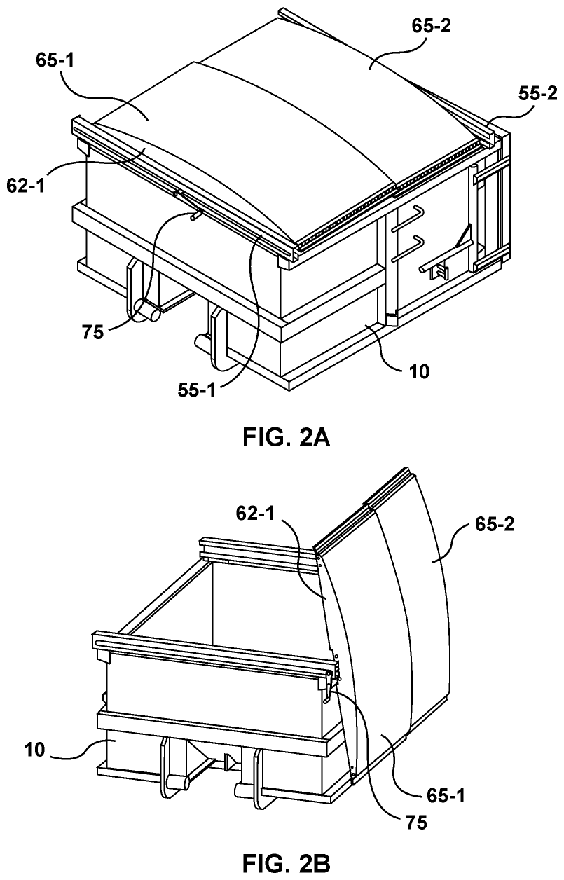

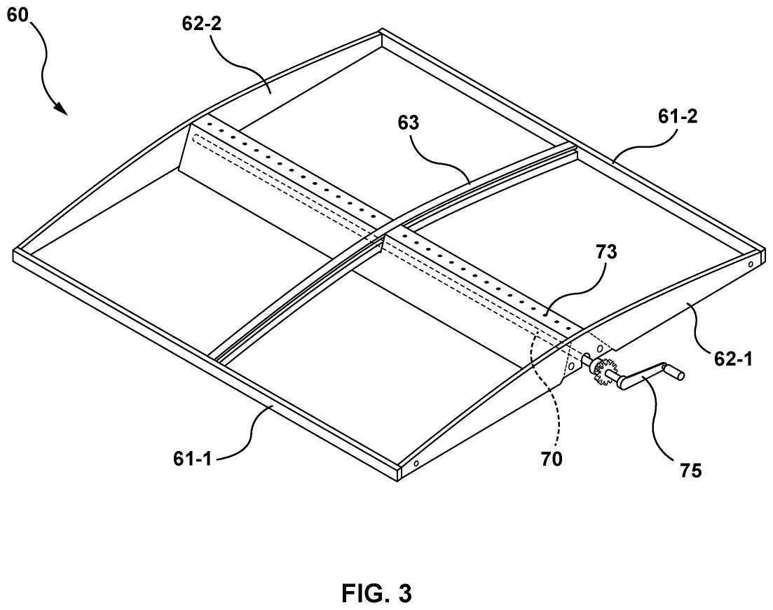

Referring to FIGS. 2A and 2B, the operation of the apparatus 50 mounted on a container 10 is generally shown. In the present example, the frame 60 moves between a closed position as shown in FIG. 2A and an open position as shown in FIG. 2B. The manner by which the apparatus 50 moves the frame 60 and panels 65 between the closed position and the open position is not particularly limited. For examples, the pinions 72-1, 72-2 may engage with the tracks 55 such that the axle 70 can move in a parallel direction to the tracks 55. The track 55-1 and the track 55-2 may be substantially symmetrical or substantially identical. In this example, each end of the axle 70 may move together by equal amounts along their respective tracks 55.

Furthermore, the movement of the axle 70 relative to the tracks 55 may be controlled by a user in the present example. In this example, the axle 70 may engage the track with a rack-and-pinion mechanism to reduce slippage between the axle 70 and each of the tracks 55. The movement may then be controlled by rotating the axle 70 such that each pinion on the axle 70 moves along the track 55 in a controlled manner. The manner by which the rotation of the axle 70 is controlled is not particularly limited. In the present example, the axle 70 may be rotated using the handle by a user. In other examples, the handle 75 may be substituted with a motor. It is to be appreciated by a person of skill with the benefit of this description that the motor may be controlled at the container with a wired controller, or remotely using wireless technology. Further examples may also incorporate smart technology to control the position of the apparatus 50, such as based on time.

In the present example, as the frame 60 and panels 65 move from the closed position (FIG. 2A) to the open position (FIG. 2B), the frame 60 is rotated about the axle 70 relative to the plane of the opening of the container 10. By rotating the frame 60, and the panels 65, more of the opening of the container 10 is exposed to provide access than if the frame 60 and accompanying panels 65 are to be simple translated along the tracks while remaining in the same plane. In particular, without rotation, approximately half of the opening would remain covered by the panels 65.

Referring to FIG. 3, the frame 60 of the present example is shown in greater detail. It is to be appreciated that the frame 60 is not particularly limited and that any structure configured to engage the tracks 55 to move between a closed position and an open position may be substituted. In the present example, the frame 60 includes longitudinal members 61-1, 61-2, cross members 62-1, 62-2, the axle 70, a cover 73 to protect the axle 70, and the handle 75. In addition, the frame includes a central cross member 63. The longitudinal members 61 and the cross members 62 form a rectangular support structure to which the panels 65 are mounted. The manner by which the longitudinal members 61 and the cross members 62 are connected is not particularly limited. For example, the longitudinal members 61 and the cross members 62 may be fastened together with fasteners such as bolts, or welded together.

The axle 70 is rotatably connected to the cross members 62 and configured to engage the tracks 55 to move the frame 60 relative to the opening of the container 10. Accordingly, the axle 70 may be made from a rigid material with mechanical properties sufficient to rotate both ends without deforming.

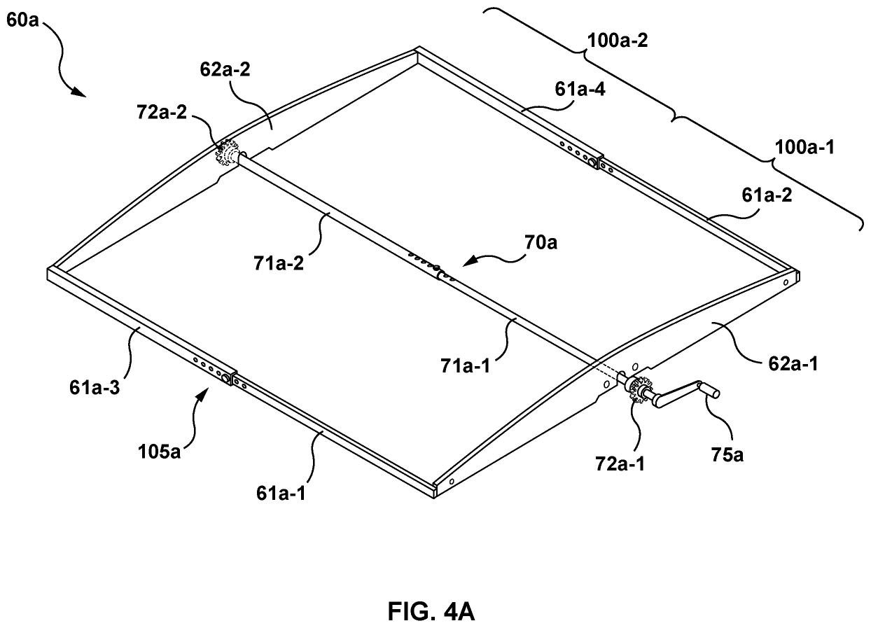

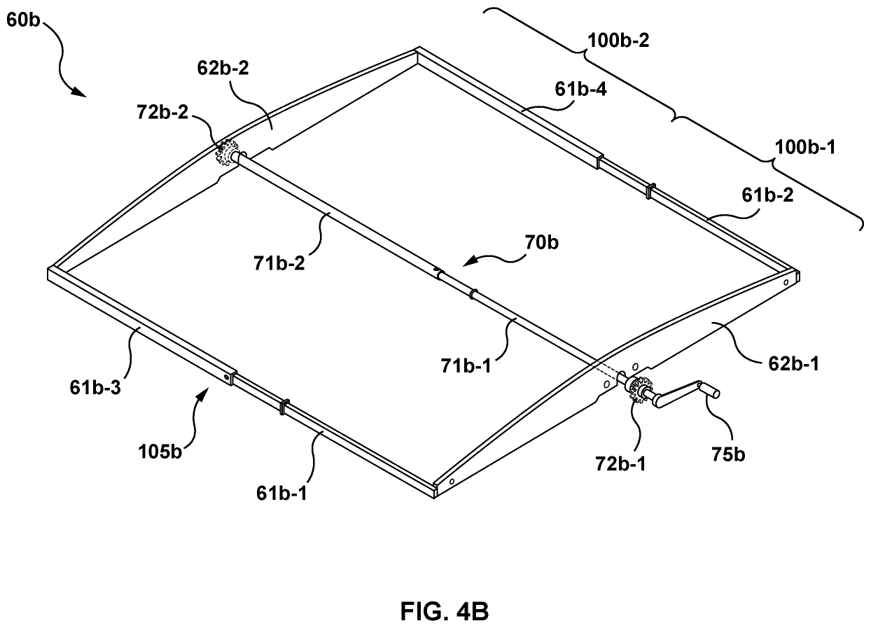

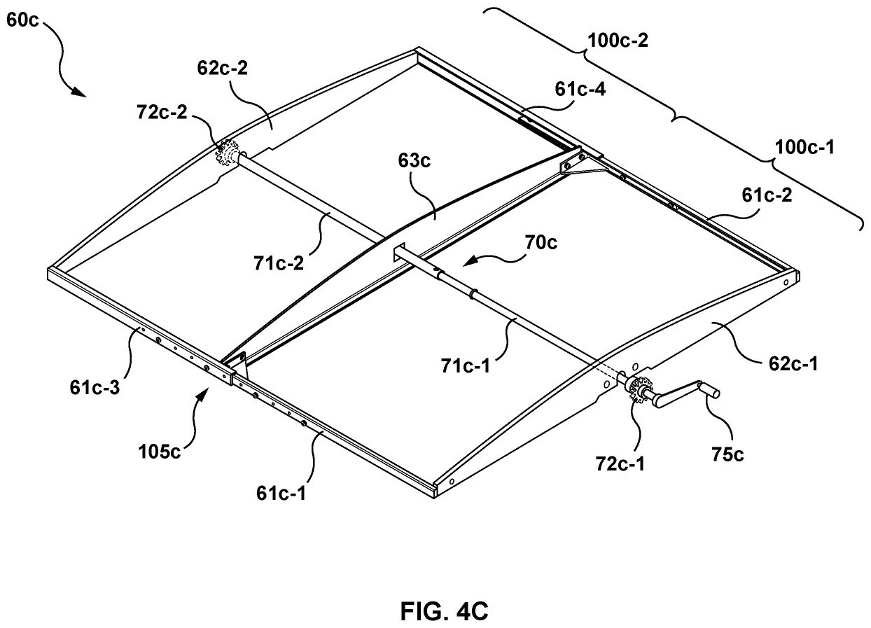

Referring to FIG. 4A, another example of a frame 60a is generally shown. Like components of the frame 60a bear like reference to their counterparts in the frame 60, except followed by the suffix “a”. In the present example, the frame 60a includes longitudinal members 61a-1, 61a-2, 61a-3, 61a-4, cross members 62a-1, 62a-2, the axle 70a, and the handle 75a. In the present example, the axle 70a may be separated into axle portions 71a-1, 71a-2. Each end of the axle 70a may include a pinion 72a-1 and 72a-2.

In the present example, the frame 60a is substantially similar to the frame 60. However, the frame 60a is adjustable to fit a dimension, such as a length of an opening of the container 10. The manner by which the frame 60a is adjusted is not particularly limited and may include various mechanisms. For example, the frame 60a may be assumed to be adjustable in a longitudinal direction (i.e. along the length of the container 10). Accordingly, the longitudinal members 61a-1, 61a-2, the cross member 62a-1, and the axle portion 71a-1 may form a first longitudinal portion 100a-1. The longitudinal members 61a-3, 61a-4, the cross member 62a-2, and the axle portion 71a-2 may form a second longitudinal portion 100a-2. The first longitudinal portion 100a-1 and the second longitudinal portion 100a-2 connects at one of the predetermined positons 105a to provide a plurality of lengths to which the frame 60a may be configured.

The connection mechanism used to connect the longitudinal member 61a-1 to the longitudinal member 61a-3 is not particularly limited. For example, each of the predetermined positions 105a may be an opening to receive a pin to secure the longitudinal member 61a-1 to the longitudinal member 61a-3. It is to be appreciated by a person of skill with the benefit of this description that the pin may be replaced by another fastener such as a bolt, screw, or rivet. In other examples, a spring loaded pin in one of the longitudinal member 61a-1 or the longitudinal member 61a-3 may be configured to engage an opening or detent in the other. Furthermore, the number of positions in the plurality of predetermined positions 105a is not particularly limited and may include a greater number or a lesser number of positions. The positions to which the frame 60a may be adjusted may be designed to fit standardized container sizes. A similar connection mechanism may be used to connect the longitudinal member 61a-2 to the longitudinal member 61a-4. In particular, the mechanism may be substantially identical to the mechanism used to connect the longitudinal member 61a-1 to the longitudinal member 61a-3.

The manner by which the axle portions 71a-1, 71a-2 are connected is also not particularly limited. For example, the axle portions 71a-1, 71a-2 may be connected in a similar manner as the longitudinal member 61a-1 is connected to the longitudinal member 61a-3. Since the axle portions 71a-1, 71a-2 are subjected to more rotational stress, it is to be appreciated with the benefit of this description that the connection may be further strengthen with complimentary features configured to mate the axle portion 71a-1 to the axle portion 71a-2. For example, the axle portion 71a-1 may include an opening with a unique non-rotatable shape to receive the axle portion 71a-2 having a complimentary shape. Accordingly, the operation of the handle 75a connected to the axle portion 71a-1 can rotate the axle portion 71a-2 in unison. It is to be understood that the handle 75a may also be attached to the axle portion 71a-2 in some examples.

It is to be appreciated by a person of skill with the benefit of this description that the frame 60a may be substituted with variants having additional features. For example, the size, shape, and relative proportions of the frame 60a are not particularly limited and may be modified to fit different sizes of openings. As another example, the cross members 62a-1, 62a-2 may also include an adjustment mechanism similar to the longitudinal members 61a-1, 61a-2, 61a-3, 61a-4 such that the frame 60a may also be adjusted for width in addition to adjust for length.

Referring to FIG. 4B, another example of a frame 60b is generally shown. Like components of the frame 60b bear like reference to their counterparts in the frame 60a, except followed by the suffix “b”. In the present example, the frame 60b includes longitudinal members 61b-1, 61b-2, 61b-3, 61b-4, cross members 62b-1, 62b-2, the axle 70b, and the handle 75b. In the present example, the axle 70b may be separated into axle portions 71b-1, 71b-2. Each end of the axle 70b may include a pinion 72b-1 and 72b-2.

In the present example, the frame 60b is substantially similar to the frame 60a. However, the frame 60b may be adjust to fit a dimension within a continuous range of positions. The manner by which the frame 60b is adjusted is not particularly limited and may include various sliding mechanisms. For example, the frame 60b may be assumed to be adjustable in a longitudinal direction via a sliding motion, such as a telescoping mechanism where the longitudinal member 61b-1 receives a portion of the longitudinal member 61b-3 and the longitudinal member 61b-2 receives a portion of the longitudinal member 61b-4. In other examples, the longitudinal member 61b-3 may receive the longitudinal member 61b-1 and/or the longitudinal member 61b-4 may receive the longitudinal member 61b-2. The longitudinal members 61b-1, 61b-2, the cross member 62b-1, and the axle portion 71b-1 may form a first longitudinal portion 100b-1. The longitudinal members 61b-3, 61b-4, the cross member 62b-2, and the axle portion 71b-2 may form a second longitudinal portion 100b-2. The first longitudinal portion 100b-1 and the second longitudinal portion 100b-2 may slidably engage within a range of positions, such as between two slide stops, so that the frame 60b may be configured to a target length. The first longitudinal portion 100b-1 and the second longitudinal portion 100b-2 may be locked in a position using a locking mechanism, such as a clamp or set screw.

The axle portions 71b-1, 71b-2 may also be slidably connected in a similar manner as the longitudinal member 61b-1 is connected to the longitudinal member 61b-3. Since the axle portions 71b-1, 71b-2 are subjected to more rotational stress, it is to be appreciated with the benefit of this description that the connection may be further strengthen with complimentary features configured to mate the axle portion 71b-1 to the axle portion 71b-2. For example, the axle portion 71b-1 may include an opening with a unique non-rotatable shape to receive the axle portion 71b-2 having a complimentary shape. The axle portion 71b-2 may telescope into the axle portion 71b-1 to adjust the overall length while maintaining rotational rigidity between the axle portions 71b-1 and 71b-2. Accordingly, the operation of the handle 75b connected to the axle portion 71b-1 can rotate the axle portion 71b-2 in unison. It is to be understood that the handle 75b may also be attached to the axle portion 71b-2 in some examples to rotate the axle portion 71b-1 as well.

The adjustable frame 60a, 60b provides various advantages a lid assembly to cover an opening on a container 10. In particular, it is to be appreciate that the frame 60a, 60b may be configured to fit an opening of a variety of lengths. Accordingly, a single frame 60a, 60b can be mass produced for a wide variety of containers 10. Furthermore, since the panels 65 may be installed on the frame 60a, 60b with a varying degree of overlap, the entire apparatus 50 (with the frame 60 substituted with the frame 60a, 60b) may be provided to cover multiple container sizes where the adjustment for the opening size may be made at assemble of the apparatus 50, such as at a site or end of the manufacturing line for the container 10. As another example, the frame 60a, 60b may also be used as a replacement part for existing installations.

Referring to FIG. 4C, another example of a frame 60c is generally shown. Like components of the frame 60c bear like reference to their counterparts in the frame 60b, except followed by the suffix “c”. In the present example, the frame 60c includes longitudinal members 61c-1, 61c-2, 61c-3, 61c-4, cross members 62c-1, 62c-2, the axle 70c, and the handle 75c. In the present example, the axle 70c may be separated into axle portions 71c-1, 71c-2. Each end of the axle 70c may include a pinion 72c-1 and 72c-2.

In the present example, the frame 60c is substantially similar to the frame 60a. However, the longitudinal members 61c-1, 61c-2, 61c-3, 61c-4 are side rails instead of telescoping members. Furthermore, the frame 60c includes an additional cross member 63c to provide support.

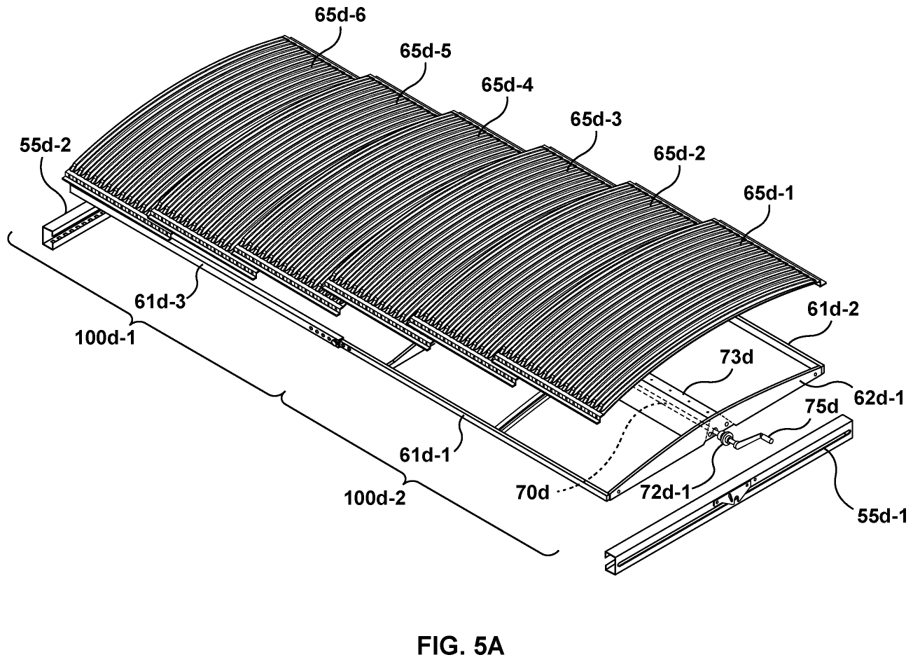

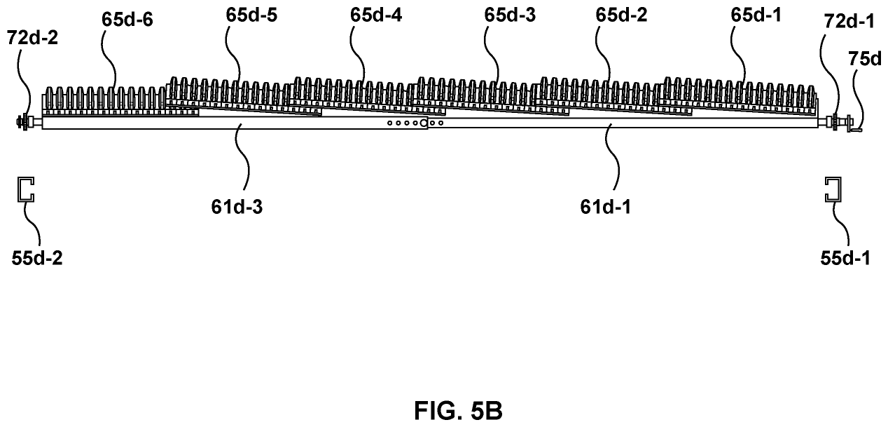

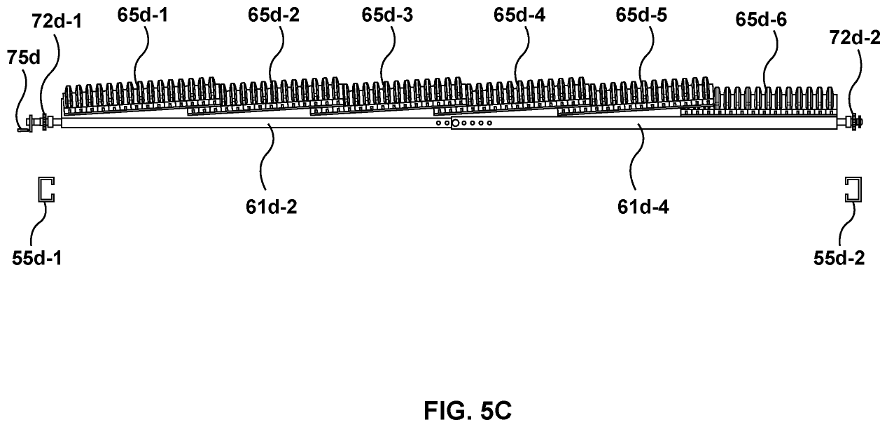

Referring to FIGS. 5A, 5B, and 5C, another example of an apparatus 50d to cover a container opening is generally shown. Like components of the apparatus 50d bear like reference to their counterparts in the apparatus 50, except followed by the suffix “d”. In the present example, the apparatus 50d includes tracks 55d-1, 55d-2 (generically, these tracks are referred to herein as “track 55d” and collectively they are referred to as “tracks 55d”, this nomenclature is used elsewhere in this description), a frame 60d, panels 65d-1, 65d-2, 65d-3, 65d-4, 65d-5, 65d-6, (generically, these panels are referred to herein as “panel 65d” and collectively they are referred to as “panels 65d”, this nomenclature is used elsewhere in this description), and a latch 80d.

In the present example, the apparatus 50d is substantially similar to the apparatus 50, except longer in length with additional panels 65d. The tracks 55d are substantially similar to the tracks 55.

In the present example, the frame 60d is substantially similar to the frame 60a or the frame 60b. In particular, the frame 60d is adjustable to fit a dimension, such as a length of an opening of the container 10. The manner by which the frame 60d is adjusted is not particularly limited and may include various mechanisms such as those described above in connection with the frame 60a and the frame 60b. In the present example, the frame 60d may be assumed to be adjustable in a longitudinal direction (i.e. along the length of the container 10). Accordingly, the longitudinal members 61d-1, 61d-2, the cross member 62d-1, and a portion of the axle 70d may form a first longitudinal portion 100d-1. The longitudinal members 61d-3, 61d-4, the cross member 62d-2, and another portion of the axle 70d may form a second longitudinal portion 100d-2. It is to be appreciated by a person of skill with the benefit of this description that in some examples, the longitudinal members 61d may be divided into more than four pieces, were each connection between two longitudinal members 61d may provide an adjustment point. Similarly, the axle 70d may be divided into more than two pieces, where each connection between two portions of the axle 70d may provide an adjustment point for the length of the total axle to match the length of the frame 60d. In the present example, the axle 70d is protected by a cover 73d which may also be divided into portions for adjustment.

The manner by which the frame 60d moves along the tracks 55d is not particularly limited and may use similar to the mechanisms as those described above. For example, the axle 70d may engage a track 55d with a rack-and-pinion mechanism. In this example, each of the tracks 55d may include a plurality of openings to form a rack. In other examples, each of the tracks 55d may include valleys or a plurality of detents to form the rack of the rack-and-pinion mechanism. The axle 70d may include a pinion 72d-1, 72d-2 at each end where the pinion 72d-1, 72d-2 is to roll along a respective track 55d. It is to be appreciated by a person of skill with the benefit of this description that a rack-and-pinion mechanism may securely engage the axle 70d to the tracks 55d such that the axle 70d will not slip relative to the tracks 55d. In particular, the lid may then be locked in a position, such as an open position or a closed position by securing a pinion 72d-1, 72d-2 from rotating. Accordingly, for examples where the pinion 72d-1, 72d-2 is locked to the axle 70d and controlled by a handle 75d, the lid may be locked in position by locking the handle 75d.

In the present example, the panels 65d are to be mounted on the frame 60d. It is to be appreciated by a person of skill that each of the panels 65d are generally smaller than the opening of the frame 60d such that each panel 65d is to cover only a portion of the opening defined by the frame 60d. In general, the panels 65d are prefabricated to be substantially identical in size. Accordingly, the panels 65d may overlap in order to fit within the frame 60d. Since the frame 60 is generally rectangular, the panels 65d may have a dimension equal to width of the frame and another dimension to be a portion of the length.

The panels 65d may include connector elements 66d to mate with corresponding connector elements 66d on adjacent panels 65d. The connector elements 66d are not particularly limited and may be any mechanism to secure the relative positions of the panels 65d. In the present example, the connector elements 66d are ribs on the panels 65d. The ribs may be uniform across the entire panel 65d such that an adjacent panel with a corresponding rib structure can may at a plurality of locations to achieve a variable amount of overlap. It is to be appreciated by a person of skill that a smaller the distance between each peak in the rib structure provides for more fine adjustments to the amount of overlap between the panels 65d. In other examples, each panel 65d may include connector elements 66d that protrusions to engage openings in an adjacent panel 65d such that they are secured from moving freely once installed. In further examples, the connector elements 66d may be an adhesive substance or a magnetic coupling system.

A plurality of overlapping panels 65d may overlap by a target distance that may vary depending on the size of the opening of the container. Therefore, the use of multiple panels 65d manufactured on the same manufacturing line may accommodate a variety of container sizes by simply adding sufficient number of panels 65d. In the present example, the panels 65d may simply overlap such that the rigidity bolstered by the rib structure of the panels 65d hold the shape.

The material from which each of each panel 65d is constructed is not particularly limited. In the present example, each panel 65d may be made from a plastic material, fiberglass, or other composite material for their lightweight and durable properties. In other examples, the panels 65d may be made from galvanized steel or other metals.

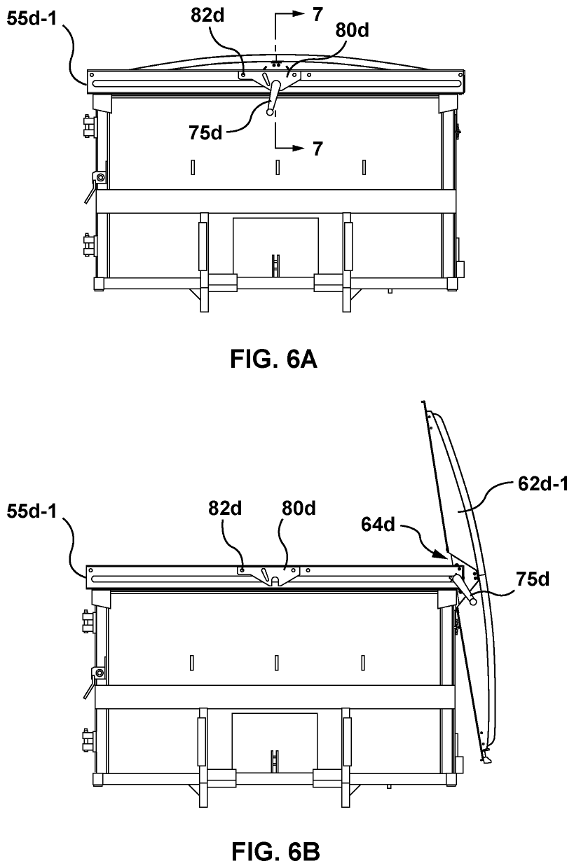

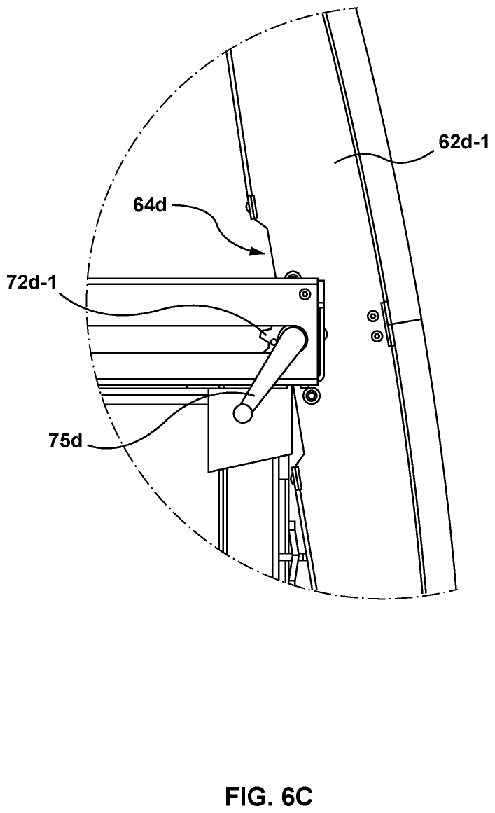

Referring to FIGS. 6A, 6B, and 6C the operation of the apparatus 50d mounted on a container 10 is generally shown. In the present example, the frame 60d and panels 65d move between a closed position as shown in FIG. 6A and an open position as shown in FIG. 6B. The frame 60d and panels 65d may move between the closed position and the open position with the pinions 72d-1, 72d-2 of the axle 70d engaging the tracks 55d-1, 55d-2, respectively, such that the axle 70d can move in a parallel direction to the tracks 55d.

Referring to FIG. 6C, a detailed view of the frame 60d and the container 10 in the open position is shown. In the present example, it is the cross member 62d-1 of the frame 60d includes a cutout 64d around the axle 70d. It is to be appreciated by a person of skill with the benefit of this description that when the frame is rotated, the cross member 62d-1 may contact a corner of the container 10 to limit the angle by which the frame 60d and the panels 65d may be rotated. Accordingly, the cutout 64d allows the frame 60 to increase the angle of rotation about the axle 70d at the edge of the container to almost 90 degrees (i.e. vertical) to provide easier access to the opening of the container 10. In the present example, the cutout 64d is symmetrical about the axle 70d such that the frame 60d may be rotated similarly at both edges of the track 55d. However, in other examples, the cutout 64d may be asymmetrical, especially for examples where the frame 60d is to be opened from a single side.

In the present example, the apparatus 50d further includes a latch 80d to lock the frame 60d and the panels 65d in the closed position. The manner by which the latch 80 secures the frame 60d and the panels 65d in the closed position is not particularly limited. For example, the latch 80d may include a mechanism to hold the axle 70d in place. In other examples, the latch 80d may lock the handle 75d to prevent the axle 70d from moving. In further examples, other locking mechanisms connecting a portion of the frame 60d to the container 10 may also be used to secure the apparatus 50d in the closed position.

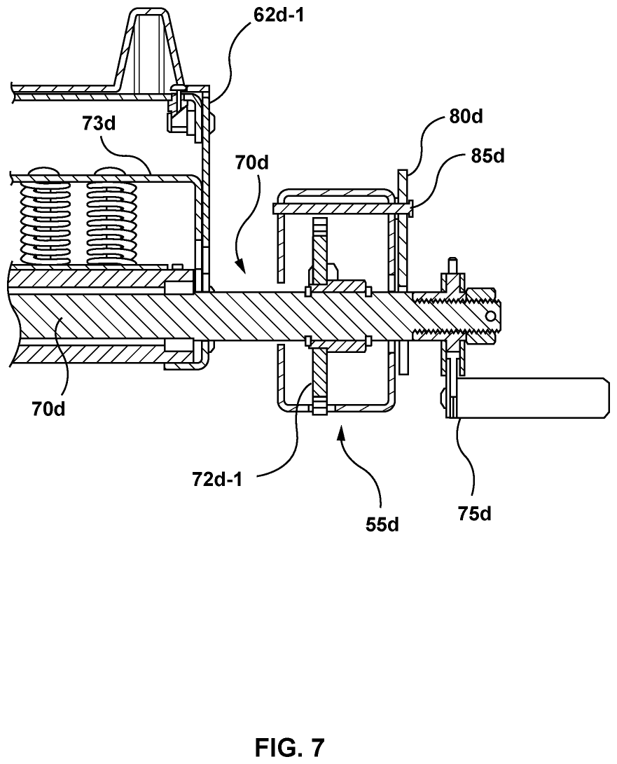

Referring to FIG. 7, a cross section of the latch 80d from FIG. 6A about the line 7-7 is shown. In the present example, the latch 80d secures the axle 70d. The latch 80d may freely rotate about a pin 82d to allow the axle 70d to pass through along the slot unrestricted. If the frame 60d is to be locked, the axle 70d may be received by the latch 80d and a locking pin 85d may be inserted to prevent the latch 80d from moving freely along the slot. If the latch 80d is locked with the locking pin 85d with the axle 70d secured by the latch 80d, the frame 60d and the panels 65d are effectively locked in the closed position to secure the contents of the container. This may be used when the container 10 is transported on a vehicle to avoid accidental openings of the apparatus during transport. In some examples, the pin 85d may include a locking mechanism to sure the latch 80d in the lowered position to effectively lock the apparatus 50d to provide security for the contents of the container 10 when left unattended.

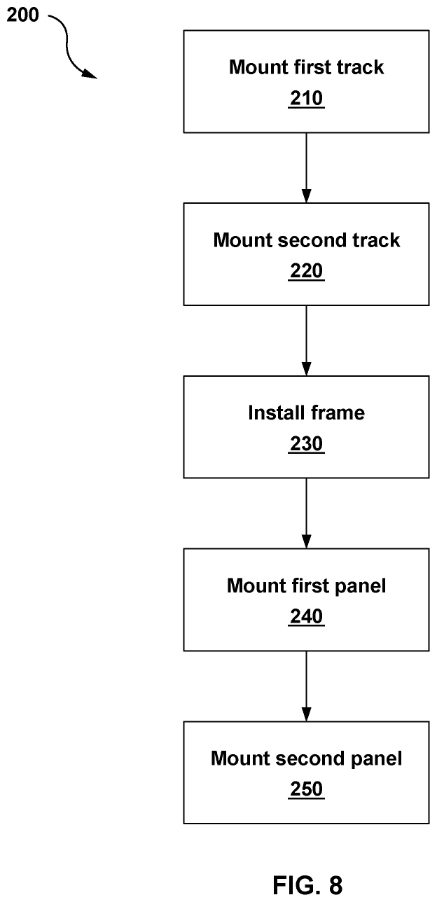

Referring to FIG. 8, a flowchart of a method of covering an opening of container 10 is generally shown at 200. In order to assist in the explanation of method 200, it will be assumed that method 200 may one exemplary way by which the apparatus 50 or its variants may be installed. Furthermore, the following discussion of method 200 may lead to a further understanding of the apparatus 50 and its components. In addition, it is to be emphasized, that method 200 may not be performed in the exact sequence as shown, and various blocks may be performed in parallel rather than in sequence, or in a different sequence altogether.

Beginning at block 210, a track 55-1 is to be mounted along a first side of the opening on the container 10. The manner by which the track 55-1 is mounted onto the container 10 is not particularly limited. For example, the track 55-1 may be mounted using a fastener, such as a rivet, bolt, or clips. In other examples, the track 55-1 may be welded or soldered onto the container. In further examples, the track 55-1 may also be mounted using magnetic coupling or other removable securing mechanisms.

At block 220, the track 55-2 is to be mounted along the opposite side of the opening of the container 10 from the track 55-1. The manner by which the track 55-2 is mounted is not limited and may be one of the methods described above in connection with block 210.

Black 230 involves installing the frame 60 to engage with the tracks 55. In the present example, the frame 60 is configured to move along the tracks 55 between an open position and a closed position. The manner by which the frame 60 engages the tracks is not particularly limited. For example, the frame 60 may include an axle 70 with a pinion 72-1 at one end to form a rack-and-pinion mechanism with the track 55-1 and another pinion 72-2 on the opposite end of the axle 79 to form a rack-and-pinion mechanism with the track 55-2.

Block 240 comprises mounting a panel 65-1 to the frame 60 to cover a first portion of the opening covered by the frame 60. It is to be appreciated by a person of skill with the benefit of this description that the panel 65-1 is generally smaller than the opening of the frame 60 such that each panel 65-1 is to cover only a portion of the opening defined by the frame 60.

Next, block 250 comprises mounting the panel 65-2. The panel 65-2 is mount to cover an additional portion of the opening covered by the frame 60. In the present example, the panel 65-2 overlaps the panel 65-1 to fit within the frame 60. It is to be appreciated that in other examples with more than two panels 65, such as the apparatus 50d, block 250 may be repeated as many times as necessary to cover the opening of the container 10.

The amount that the panel 65-2 overlaps the panel 65-1 is not fixed and may be adjusted to fit the size of the frame 60 above the opening of the container 10. Accordingly, the apparatus 50 assembled using method 200 may cover openings of varying sizes by changing the amount that the panel 65-2 overlaps the panel 65-1. In some examples, the panel 65-2 may be connected to the panel 65-1 with a connector element engaging a complimentary connector element. It is to be appreciated that the use of additional panels 65 may provide for greater versatility of the apparatus 50 being applied to different containers 10.

It is to be appreciated by a person of skill with the benefit of this description that variants are possible. For example, the apparatus 50 may be substituted with the apparatus 50d where the frame 60d may be adjusted in length to fit openings of varying sizes. The manner by which he frame 60d may be adjusted is not particularly limited. For example, the frame 60d may include longitudinal members 61d-1, 61d-2, the cross member 62d-1, and the axle portion 71d-1 to form a first longitudinal portion 100d-1. The frame 60d may also include longitudinal members 61d-3, 61d-4, the cross member 62d-2, and the axle portion 71d-2 to form a second longitudinal portion 100d-2. The first longitudinal portion 100a-1 and the second longitudinal portion 100d-2 may connect at one of the predetermined positons to provide a plurality of lengths to which the frame 60d may be configured.

It should be recognized that features and aspects of the various examples provided above may be combined into further examples that also fall within the scope of the present disclosure.

1. An apparatus comprising:
a first track to mount on a container along a first side of a container opening;
a second track to mount on the container along a second side of the container opening, wherein the first side is opposite the second side;
a frame engaged with the first track and the second track, wherein the frame is to move along the first track and the second track between an open position and a closed position,
a first panel to mounted on the frame to cover a first portion of the container opening; and
a second panel to mounted on the frame to cover a second portion of the container opening, wherein the first panel is to overlap the second panel by a target distance, and wherein the target distance is dependent on a size of the container opening.

2. The apparatus of claim 1, wherein the frame is adjustable to fit a dimension of the container opening.

3. The apparatus of claim 2, wherein the frame includes first longitudinal portions and second longitudinal portions, wherein the first longitudinal portions and the second longitudinal portions are to engage at one of a plurality of predetermined positions to adjust a length of the frame.

4. The apparatus of claim 2, wherein the frame includes first longitudinal portions and second longitudinal portions, wherein the first longitudinal portions and the second longitudinal portions are to engage within a range of positions to adjust a length of the frame.

5. The apparatus of claim 1, wherein the frame is rotated about an axle relative to the container opening in the open position to facilitate access to the container opening.

6. The apparatus of claim 5, further comprising a cutout on the frame around the axle to increase an angle of rotation about the axle at an edge of the container.

7-8. (canceled)

9. The apparatus of claim 1, wherein the first panel includes a first connector element to mate with a second connector element of the second panel, wherein the first connector element is a first plurality of ribs to mate with a second plurality of ribs of the second panel, and wherein the first plurality of ribs and the second plurality of ribs are uniform to allow for variable overlapping.

10-12. (canceled)

13. A kit of parts for use to cover a container with an opening, the kit comprising:
a first track to mount on the container along a first side of the opening;
a second track to mount on the container along a second side of the opening, wherein the first side is opposite the second side;
a frame to engage with the first track and the second track, wherein the frame is to move along the first track and the second track between an open position and a closed position,
a first panel to be mounted on the frame to cover a first portion of the opening; and
a second panel to be mounted on the frame to cover a second portion of the opening, wherein the first panel overlaps the second panel by a target distance, and wherein the target distance is dependent on a size of the opening.

14. The kit of claim 13, wherein the frame is adjustable to fit a dimension of the container opening.

15. The kit of claim 14, wherein the frame includes:
a first longitudinal element;
a second longitudinal element;
a third longitudinal element; and
a fourth longitudinal element,
wherein the first longitudinal element and the second longitudinal element are to engage at a first predetermine position and the third longitudinal element and the fourth longitudinal element are to engage at a second predetermine position to adjust a length of the frame.

16. The kit of claim 14, wherein the frame includes:
a first longitudinal element;
a second longitudinal element;
a third longitudinal element; and
a fourth longitudinal element,
wherein the first longitudinal element and the second longitudinal element are to engage within a first range of relative positions and the third longitudinal element and the fourth longitudinal element are to engage within a second range of relative positions to adjust a length of the frame.

17. The kit of claim 13, further comprising an axle to be rotatably connected to the frame, the axle having a first end and a second end, wherein the first end is to engage with the first track and the second end is to engage the second track.

18. The kit of claim 17, wherein the frame includes a cutout around the axle to increase an angle of rotation about the axle at an edge of the container.

19-20. (canceled)

21. The kit of claim 13, wherein:
the first panel includes a first plurality of ribs; and
the second panel includes a second plurality of ribs, wherein the second panel is substantially similar to the first panel;
wherein the first plurality of ribs is configured to mate with the second plurality of ribs.

22-23. (canceled)

24. The kit of claim 13, wherein the first panel and the second panel comprises a lightweight plastic.

25. (canceled)

26. A method comprising:
mounting a first track to a container along a first side of an opening;
mounting a second track to the container along a second side of the opening, wherein the first side is opposite the second side;
installing a frame to engage with the first track and the second track, wherein the frame is configured to move along the first track and the second track between an open position and a closed position,
mounting a first panel to the frame, wherein the first panel is to cover a first portion of the opening; and
mounting a second panel to the frame, wherein the second panel is to cover a second portion of the opening, wherein the first panel overlaps the second panel by an adjustable distance dependent on a size of the opening.

27. The method of claim 26, further comprising adjusting a length of the frame to fit the opening.

28. (canceled)

29. The method of claim 27, wherein adjusting the length of the frame comprises engaging a first longitudinal portion and a second longitudinal portion within a range of positions.

30. (canceled)

31. The method of claim 26, wherein mounting the second panel to the frame comprises mating a first connector element on the first panel with a second connector element on the second panel.

32. The method of claim 31, wherein mating the first connector element with the second connector element comprises interlocking a first plurality of ribs on the first panel with a second plurality of ribs on the second panel.
